(19) United States
(12) Patent Application Publication
(10) Pub. No.: US 2010/0242551 A1
(43) Pub. Date: Sep. 30, 2010

(54) PADLOCK WITH INDICATION DEVICE

(76) Inventor: CHUN TE YU, Changhua County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/814,183

(22) Filed: Jun. 11, 2010

Related U.S. Application Data
(63) Continuation-in-part of application No. 11/491,258, filed on Jul. 24, 2006, now Pat. No. 7,770,421.
Application No. 11/491,258 is a continuation-in-part of application No. 11/032,116, filed on Jan. 11, 2005, now Pat. No. 7,100,401.

(30) Foreign Application Priority Data
Nov. 23, 2004 (TW) 93218813

(51) Int. Cl. E05B 67/10

(52) U.S. Cl. 70/41

(57) ABSTRACT

A padlock includes a housing, a shackle, a limit knob, a movable block and a lock core. The housing has an opening in a wall thereof. The shackle has a shaft portion movably mounted in the housing, and a locking portion extended from the shaft portion and located outside of the housing. The limit knob is partly received in the housing via the opening and has a button located outside of the housing. The movable block is disposed on the limit knob and capable of moving to a predetermined position which is outside of the housing. The lock core has a rotor configured to be driven by a key so as to move the limit knob to a first position where the button of the limit knob keeps the shackle from rotating and a second position where the button of the limit knob allows the shackle to rotate.

### CROSS REFERENCE TO RELATED APPLICATION

This is a continuation-in-part of the U.S. Ser. No. 11/491,258 application filed on Jul. 24, 2006, which is a continuation-in-part of U.S. Pat. No. 7,100,401 issued on Sep. 5, 2006.

### BACKGROUND OF INVENTION

1. Field of Invention

The present invention relates to a padlock, and more particularly to a padlock with an indication device for reminding a padlock owner whose padlock has been operated or used and luggage may have been inspected by the customs.

2. Description of Related Art

A conventional dual lock or padlock generally includes a shell, a shackle installed on the shell, a first locking mechanism installed on the shell to lock and unlock the shackle, and a second locking mechanism installed on the shell to lock and unlock the shackle. The first locking mechanism can only be unlocked by a padlock owner while the second locking mechanism can be unlocked only by a specific key. The specified key is often held by a customs inspector who is authorized to unlock the second locking mechanism of the padlock when it is necessary to open and check a luggage, a case or a bag subject to the lock or padlock without breaking it. Then, the inspector can re-lock the lock or padlock via the second locking mechanism by the specified key after inspecting the luggage, case or bag. However, an owner of such a luggage, case or bag cannot judge by the appearance of the lock or padlock if the lock or padlock has been operated or used and the luggage, case or bag has been checked that would cause great inconvenience to the owner.

### SUMMARY OF INVENTION

The primary objective of the present invention is to provide a padlock capable of reminding a padlock owner whose padlock has been operated or used and luggage may have been inspected by the customs.

In one embodiment of the present invention, a padlock comprises a housing, a shackle, a lock mechanism and a movable block. The housing defines an opening at a wall thereof to communicate an interior space of the housing and the outside of the housing. The shackle is mounted on the housing and has a first end formed with a shaft portion movably mounted in the housing, and a second end formed with a locking portion moved with the shaft portion and extended from the shaft portion. The lock mechanism is mounted on the housing, and includes a lock core and a limit knob. The lock core is mounted in the housing. The limit knob comprises a driving member and a button. The driving member is displaceable within the interior space of the housing via the opening. The button is coupled to the driving member and located outside of the housing. The driving member is displaceable by the lock core so as to drive the button to engage or disengage with the locking portion of the shackle. The movable block is disposed in the opening of the housing and capable of moving along a surface of the driving member from the opening of the housing to an indication position outside of the housing by operating the lock core of the lock mechanism.

Further benefits and advantages of the present invention will become apparent after a careful study of the detailed description with reference to the accompanying drawings.

### BRIEF DESCRIPTION OF DRAWINGS

FIG. 1 is a cutaway view of a padlock in accordance with a first embodiment of the present invention.

FIG. 2 is a perspective view of the padlock shown in FIG. 1.

FIG. 3 is another perspective view of the padlock shown in FIG. 1.

FIG. 4 is a perspective view of the padlock in another position than that is shown in FIG. 3.

FIG. 5 is an exploded partial view of the padlock shown in FIG. 1.

FIG. 6 is another exploded partial view of the padlock shown in FIG. 1.

FIG. 7 is an exploded partial view of the padlock in another position than that is shown in FIG. 5.

FIG. 8 is a perspective partial view of the padlock shown in FIG. 1.

FIG. 9 is a side view of the padlock shown in FIG. 1.

FIG. 10 is a side view of the padlock in another position than that is shown in FIG. 9.

FIG. 11 is a perspective view of a padlock in accordance with a second embodiment of the present invention.

FIG. 12 is an exploded partial view of the padlock shown in FIG. 11.

FIG. 13 is a top view of the padlock shown in FIG. 12.

FIG. 14 is a top view of the padlock in another position than that is shown in FIG. 13.

FIG. 15 is a top view of the padlock in another position than that is shown in FIG. 14.

FIG. 16 is a perspective view of a padlock in accordance with a third embodiment of the present invention.

FIG. 17 is a perspective view of a padlock in accordance with a fourth embodiment of the present invention.

FIG. 18 is a front view of a padlock in accordance with a fifth embodiment of the present invention.

FIG. 19 is a front view of a padlock in accordance with a sixth embodiment of the present invention.

FIG. 20 is a front view of a padlock in accordance with a seventh embodiment of the present invention.

FIG. 21 is a front view of a padlock in accordance with an eighth embodiment of the present invention.

FIG. 22 is a perspective view of a padlock in accordance with a ninth embodiment of the present invention.

FIG. 23 is a front view of the padlock shown in FIG. 22.

FIG. 24 is a front view of a padlock in accordance with a tenth embodiment of the present invention.

FIG. 25 is a front view of a padlock in accordance with an eleventh embodiment of the present invention.

### DETAILED DESCRIPTION OF INVENTION

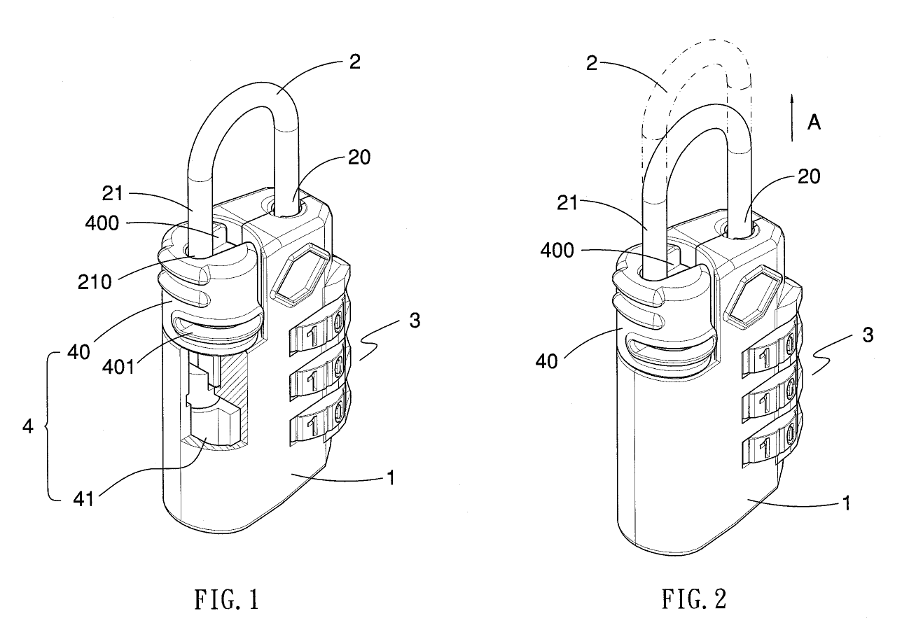

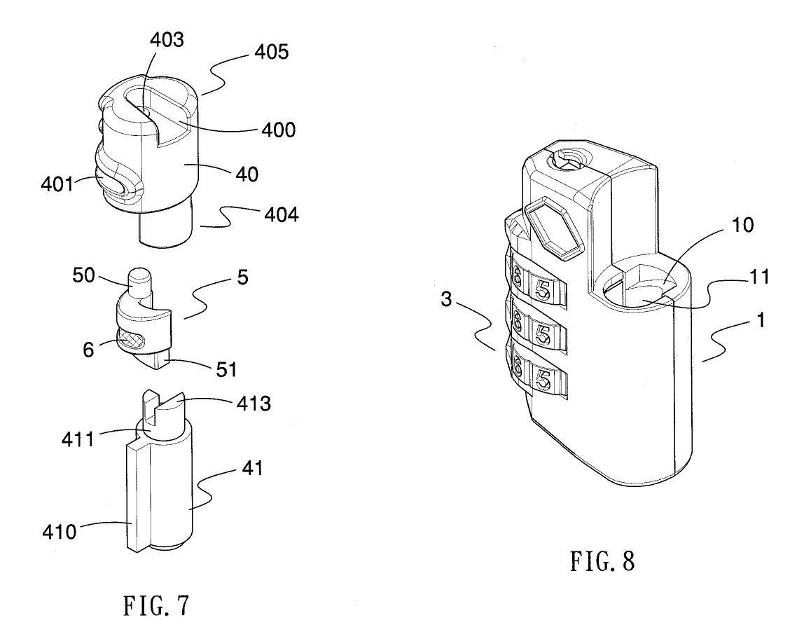

FIGS. 1-10 show a padlock as a first embodiment of the present invention. As shown in FIGS. 1-5, the padlock comprises a housing 1, a shackle 2, a lock mechanism 4, and a movable block 5. The lock mechanism 4 can be a key lock mechanism or a number lock mechanism. In the present invention, the lock mechanism 4 is preferably the key lock mechanism.

In the first embodiment, the housing 1 defines an opening 11, as can be seen in FIG. 8, in a wall thereof to communicate an interior space of the housing 1 and the outside of the housing 1. The shackle 2 is substantially U-shaped and mounted on the housing 1. The shackle 2 includes a first end formed with a shaft portion 20 movably mounted in the housing 1, and a second end formed with a locking portion 21 moved with the shaft portion 20 and extended from the shaft portion 20.

The lock mechanism 4 is mounted on the housing 1, and includes a lock core 41 and a limit knob 40. The lock core 41 is mounted in the housing. The limit knob 40 comprises a driving member 404 and a button 405. The driving member 404 is displaceable within the interior space of the housing 1 via the opening 11 of the housing 1. The button 405 is coupled to the driving member 404 and located outside of the housing 1. The driving member 404 is displaceable by the lock core 41 so as to drive the button 405 to engage or disengage with the locking portion 21 of the shackle 2. Additionally, the button 405 of the limit knob 40 includes a top face formed with a recess 400 for receiving an end 210 of the locking portion 21 of the shackle 2. The recess 400 includes an open end at a periphery of the limit knob 40.

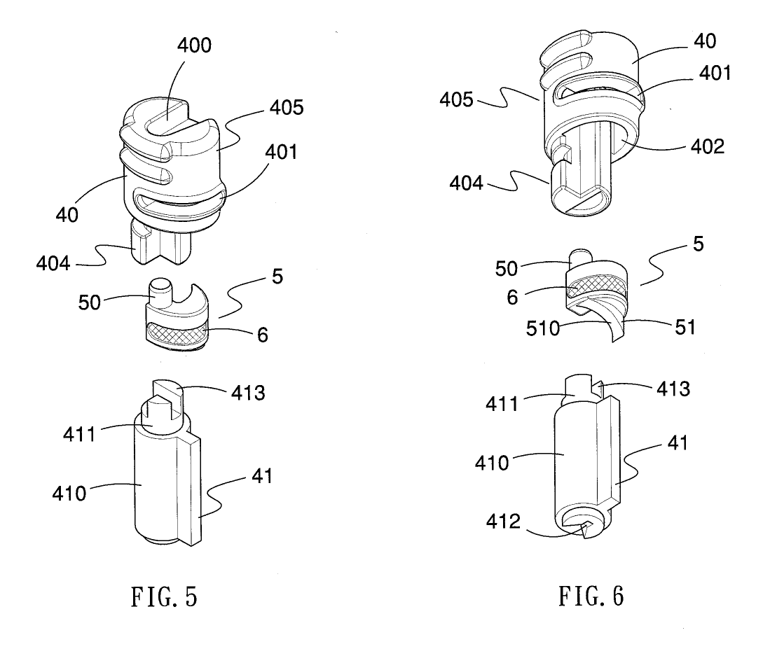

Furthermore, the movable block 5 is disposed within the opening 11 of the housing 1 and is capable of moving along a surface of the driving member 404 from the opening 11 of the housing 1 to an indication position outside of the housing 1 by operating the lock core 41 of the lock mechanism 4, as shown in FIGS. 5-10.

FIGS. 4-6 show that the padlock further comprises an indication member 6 provided on the movable block 5. The button 405 of the limit knob 40 defines a window 401 in the periphery. In the first embodiment, the indication member 6 is visible from the window 401 of the button 405 when the movable block 5 is located in the indication position.

As described above, the lock mechanism 4 is preferably the key lock mechanism. Accordingly, the lock core 41 of the lock mechanism 41 comprises a body 410 and a rotor 411. The rotor 411 is movably received in the body 410, and has one end defining a keyhole portion 412, and the other end defining a driving portion 413 extending from the body 410 for connecting with the limit knob 40. The keyhole portion 412 of the rotor 411 is arranged for receiving a matching key (not shown). When the matching key is inserted into the keyhole portion 412, the driving portion 413 can correspondingly drive the limit knob 40 to move.

In addition, the padlock of the present invention further comprises a number lock unit 3, which is mounted in the housing 1 for locking and unlocking the shaft portion 20 of the shackle 2, as shown in FIGS. 1-4.

FIG. 2 shows that the open end of the recess 400 of the limit knob 40 is directed toward and sealed by the housing 1, and the locking portion 21 of the shackle 2 is extended into and stopped by the recess 400 of the limit knob 40 of the lock mechanism 4. That is, the shackle 2 is stopped by the limit knob 40, thus forming a locked state. When the number lock unit 3 is unlocked, the shaft portion 20 of the shackle 2 is unlocked from the number lock unit 3 so that the shackle 2 is movable in a direction indicated by an arrow head A, so as to detach the locking portion 21 of the shackle 2 from the recess 400 of the limit knob 40 of the lock mechanism 4, thereby forming an unlocked state.

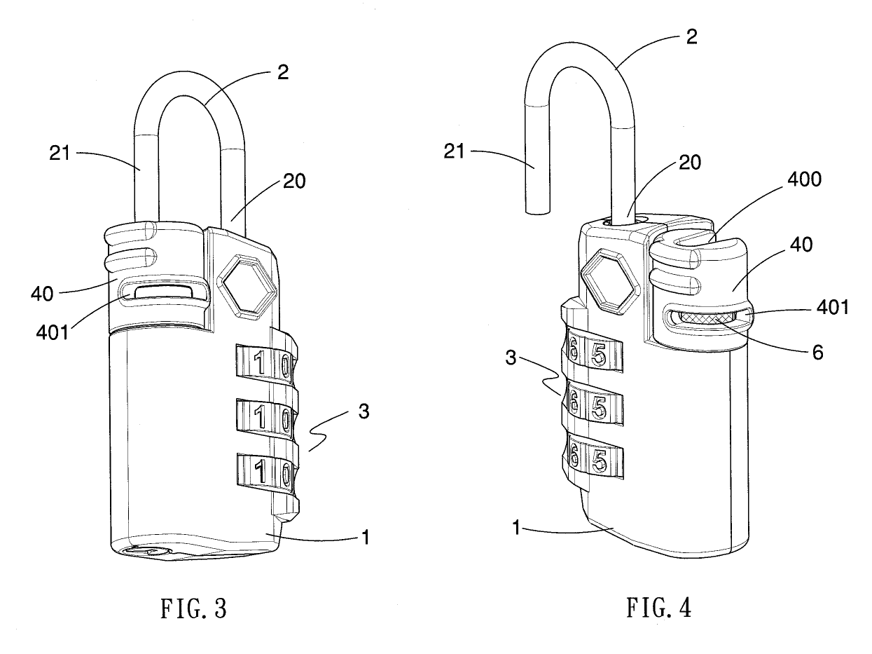

Referring to FIG. 3, when the number lock unit 3 is locked, the shaft portion 20 of the shackle 2 is locked by the number lock unit 3. That is, the locking portion 21 of the shackle 2 is stopped by the limit knob 40, thereby forming a locked state.

In FIG. 4, when the limit knob 40 of the lock mechanism 4 is moved by the lock core 41 via the matching key, the open end of the recess 400 of the limit knob 40 is released from the housing 1. Accordingly, the locking portion 21 of the shackle 2 is released from the recess 400 of the limit knob 40 and can be rotated about the shaft portion 20 of the shackle 2, thereby forming an unlocked state.

FIG. 5 shows that the movable block 5 is movably mounted on the driving member 404 of the limit knob 40 of the lock mechanism 4 and includes a first side provided with a shaft 50 directed toward the limit knob 40. The indication member 6 is provided on the movable block 5 and is visible from the window 401 of the limit knob 40 when the movable block 5 is located in the indication position. Preferably, the indication member 6 is a color, character, number or pattern. For examples, the indication member 6 is printed in red, and the movable block 5 is printed in green. Hence, the red of the indication member 6 visible from the window 401 presents the lock core 41 of the lock mechanism 4 is operated or used.

Furthermore, FIGS. 6-8 show that the button 405 of the limit knob 40 is formed with a chamber 402 facing the housing 1 for receiving the movable block 5. The movable block 5 includes a second side provided with a guide portion 51 formed with a first ramp 510. The recess 400 of the limit knob 40 includes an aperture 403 in communication with the chamber 402. The shaft 50 of the movable block 5 can be inserted into the aperture 403 of the limit knob 40. Additionally, the housing 1 is formed with a second ramp 10 complementarily touchable with the first ramp 510 of the guide portion 51 of the movable block 5.

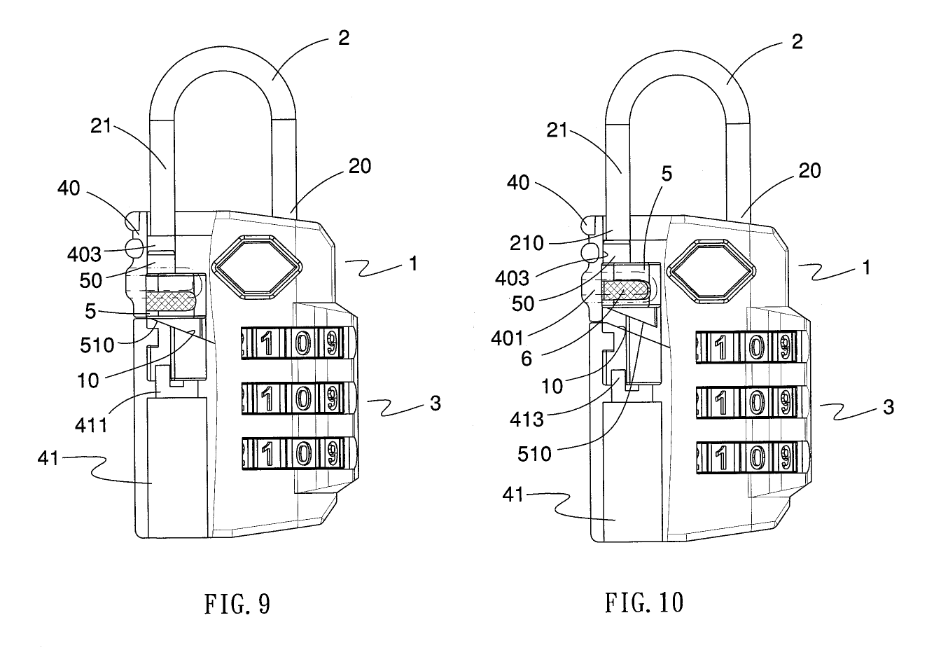

Referring to FIG. 9, the first ramp 510 of the movable block 5 and the second ramp 10 of the housing 1 complementarily touch each other so that the indication member 6 is hidden in the housing 1 and detached from the window 401 of the limit knob 40, which indicates that the lock mechanism 4 is not been operated or used. In FIG. 10, when the driving portion 413 of the rotor 411 of the lock mechanism 4 is rotated by the matching key, the limit knob 40 is rotated accordingly until the open end of the recess 400 of the limit knob 40 is released from the housing 1. Therefore, the locking portion 21 of the shackle 2 is released from the recess 400 of the limit knob 40 and is rotated freely about the shaft portion 20 of the shackle 2 to the unlocked state. At the time, the shaft 50 of the movable block 5 is moved further to extend into the aperture 403 of the limit knob 40 so that when the limit knob 40 is rotated by the lock core 41, the movable block 5 is driven by the limit knob 40. In such a manner, the movable block 5 is lifted to the indication position by engagement between the first ramp 510 of the movable block 5 and the second ramp 10 of the housing 1 so that the indication member 6 is exposed and visible from the window 401 of the limit knob 40.

After the limit knob 40 is again rotated by the lock core 41 to re-lock the locking portion 21 of the shackle 2, the movable block 5 is limited by the chamber 402 and the aperture 403 of the limit knob 40 so that the movable block 5 cannot be moved along with the driving member 404 of the limit knob 40 and still kept at the indication position, which indicates that the lock mechanism 4 has been operated. Additionally, when the number lock unit 3 is unlocked, the end 210 of the locking portion 21 of the shackle 2 can be used to press downward into the aperture 403 of the limit knob 40 so as to push the shaft 50 of the movable block 5 downward to make the movable block 5 pushed away from the indication position, namely to reset the indication member 6. Alternatively, the shackle 2 can be pulled outward and rotated away from the limit knob 40 so as to allow an insert (not shown) inserting into the aperture 403 of the limit knob 40 to push the shaft 50 of the movable block 5 downward to make the movable block 5 pushed away from the indication position.

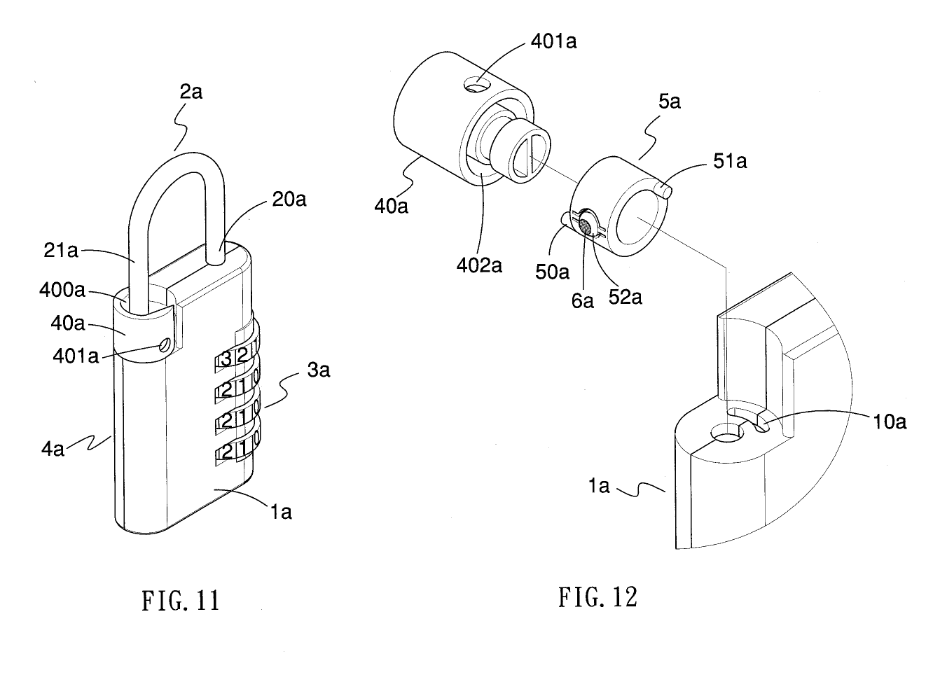

Referring to FIG. 11, a padlock in accordance with a second embodiment of the present invention includes a structure like that of the first embodiment.

Referring to FIG. 12, a housing 1a defines an arc-shaped slot 10a, and a movable block 5a includes a first side provided with a first post 50a and a second side provided with a second post 51a mounted in the slot 10a of the housing 1a in a sliding manner. The movable block 5a includes a periphery provided with an elastic protrusion 52a corresponding to the window 401a of the limit knob 40a, and the indication member 6a is mounted on the elastic protrusion 52a.

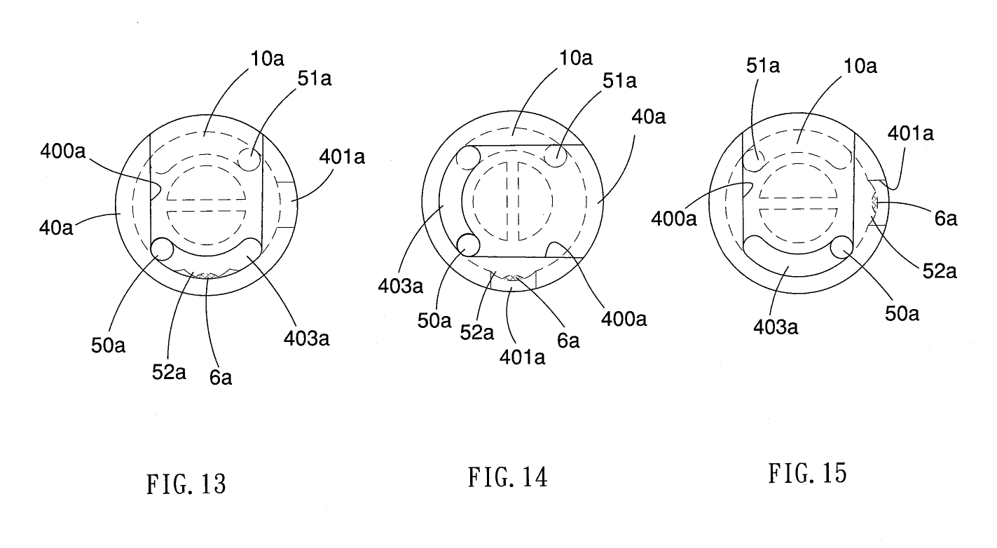

Referring to FIG. 13, a recess 400a of a limit knob 40a defines an arc-shaped slot 403a in communication with a chamber 402a, and the first post 50a of a movable block 5a is mounted in the slot 403a of the limit knob 40a in a sliding manner.

Referring to FIG. 14, the limit knob 40a is rotated clockwise so that the recess 400a of the limit knob 40a is located at the opened or unlocked state. At the time, the second post 51a of the movable block 5a is limited by a terminal side of the slot 10a of the housing 1a so that the movable block 5a is not moved with the limit knob 40a, while a window 401a of the limit knob 40a is moved and to aligned with the elastic protrusion 52a so that the indication member 6a is exposed and visible from the window 401a of the limit knob 40a.

Referring to FIG. 15, the limit knob 40a is rotated counterclockwise to the original position so that the recess 400a of the limit knob 40a is located at the closed or locked state. At this time, the elastic protrusion 52a is inserted into the window 401a of the limit knob 40a so that the movable block 5a is moved with the limit knob 40a, and the indication member 6a is still exposed from the window 401a of the limit knob 40a, which indicates that the lock mechanism 4a has been operated.

When the number lock unit 3a is unlocked, the shackle 2a is pulled outward and is rotate from the limit knob 40a. Then, a tool (not shown) can be inserted into the slot 403a of the limit knob 40a to cause the first post 50a of the movable block 5a to return to its original position so that the indication member 6a is detached from the window 401a of the limit knob 40a and is hidden in the limit knob 40a.

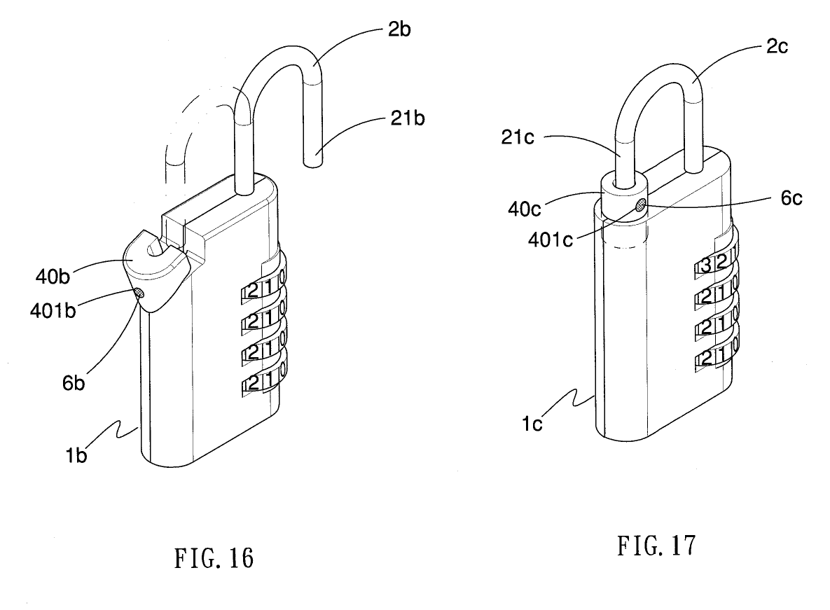

Referring to FIG. 16, a padlock in accordance with a third embodiment of the present invention includes a structure like that of the above embodiments. A limit knob 40b is pivotally mounted on an upper side of a housing 1b to limit a locking portion 21b of a shackle 2b so that the locking portion 21b of the shackle 2b is located at a locked state, or release the locking portion 21b of the shackle 2b so that the locking portion 21b of the shackle 2b is located at an unlocked state. When the locking portion 21b of the shackle 2b is located at the unlocked state, the indication member 6b is moved with the limit knob 40b and is visible from a window 401b of the limit knob 40b.

Referring to FIG. 17, a padlock in accordance with a fourth embodiment of the present invention includes a structure like that of the above embodiments. A limit knob 40c is retractably mounted on an upper side of a housing 1c to limit a locking portion 21c of a shackle 2c so that the locking portion 21c of the shackle 2c is located at a locked state, or release the locking portion 21c of the shackle 2c so that the locking portion 21c of the shackle 2c is located at an unlocked state. When the locking portion 21c of the shackle 2c is located at the unlocked state, the indication member 6c is moved with the limit knob 40c and exposed from a window 401c of the limit knob 40c.

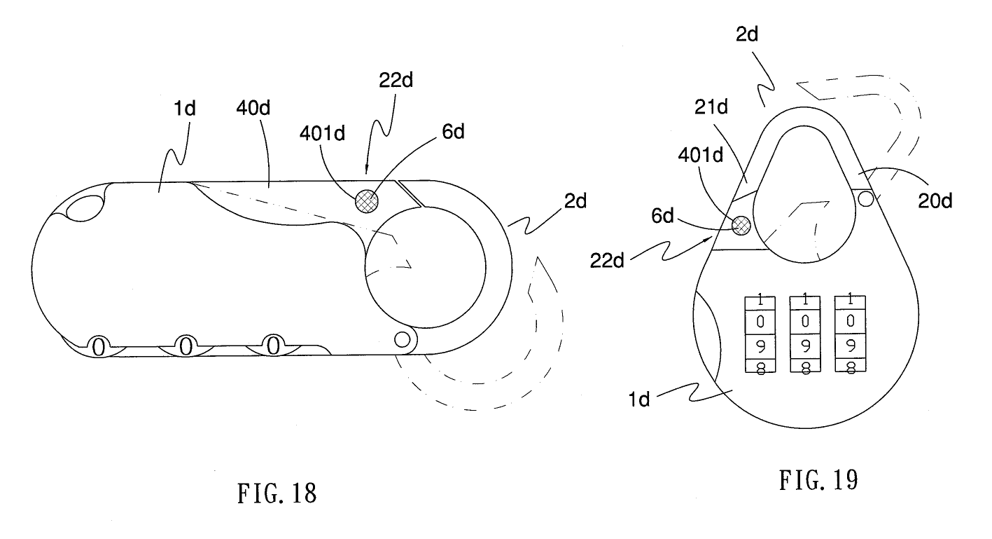

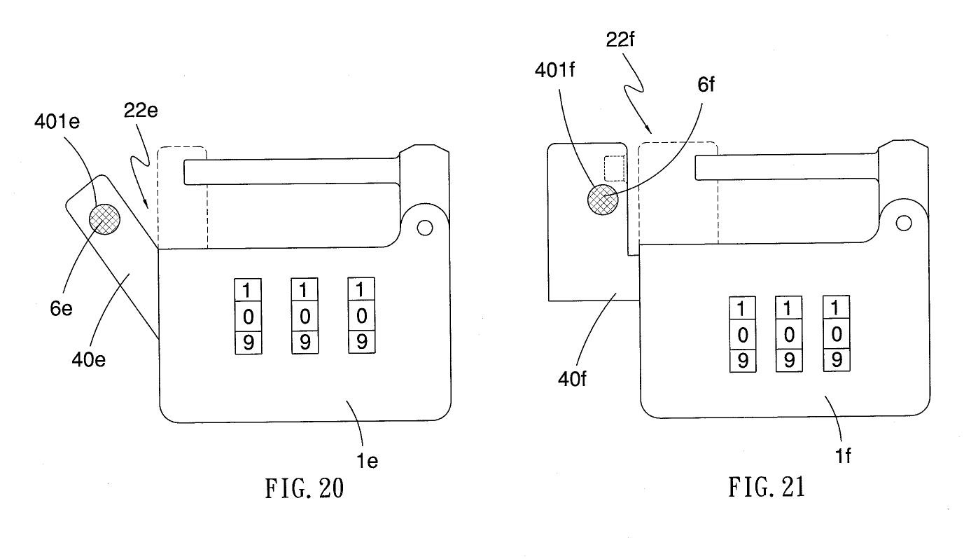

FIG. 18 shows a fifth embodiment of the present invention, and FIG. 19 shows a sixth embodiment of the present invention. Both embodiments respectively show a padlock includes a structure like that of the above embodiments. A shaft portion 20d of a shackle 2d is pivotally mounted on a side of a housing 1d, and a gap 22d is defined between an end of a locking portion 21d of a shackle 2d and the housing 1d. A limit knob 40d is pivotally mounted on the housing 1d and inserted in the gap 22d to form a locked state. As the limit knob 40d is pressed towards the housing 1d, the gap 22d is opened to form an unlocked state so that the indication member 6d is moved with the limit knob 40d and exposed from a window 401d of the limit knob 40d.

Referring to FIG. 20, a padlock in accordance with a seventh embodiment of the present invention includes a structure like that of the above embodiments. A limit knob 40e is pivotally mounted on the housing 1e and inserted in a gap 22e to form a locked state. When the limit knob 40e is moved outward relative to the housing 1e, the gap 22e is opened to form an unlocked state so that the indication member 6e is moved with the limit knob 40e and exposed from a window 401e of the limit knob 40e.

Referring to FIG. 21, a padlock in accordance with an eighth embodiment of the present invention includes a structure like that of the above embodiments. A limit knob 40f is linearly and movably mounted on a housing if and inserted in a gap 22f to form a locked state. As the limit knob 40f is linearly moved outward relative to the housing 1f, the gap 22f is opened to form an unlocked state so that an indication member 6f is moved with the limit knob 40f and exposed from a window 401f of the limit knob 40f.

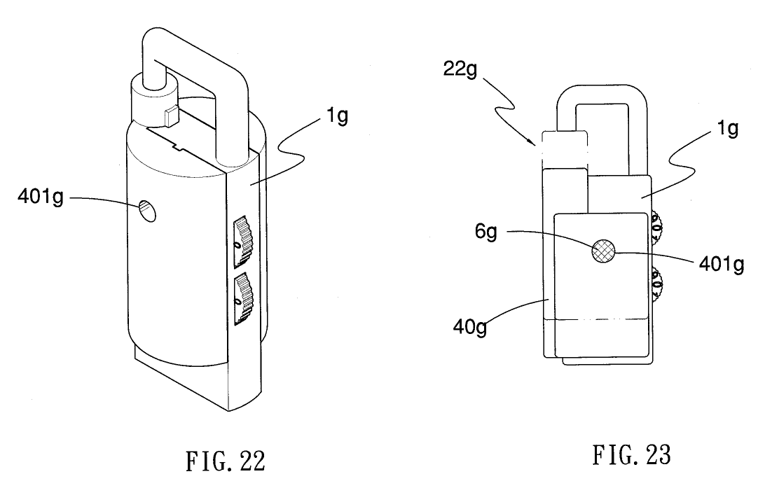

Referring to FIGS. 22 and 23, a padlock in accordance with a ninth embodiment of the present invention includes a structure like that of the above embodiments. A limit knob 40g is partially extended from a side of a housing 1g and is longitudinally movable on the housing 1g to open a gap 22g so as to form an unlocked state so that an indication member 6g is moved with the limit knob 40g and exposed from a window 401g of the limit knob 40g.

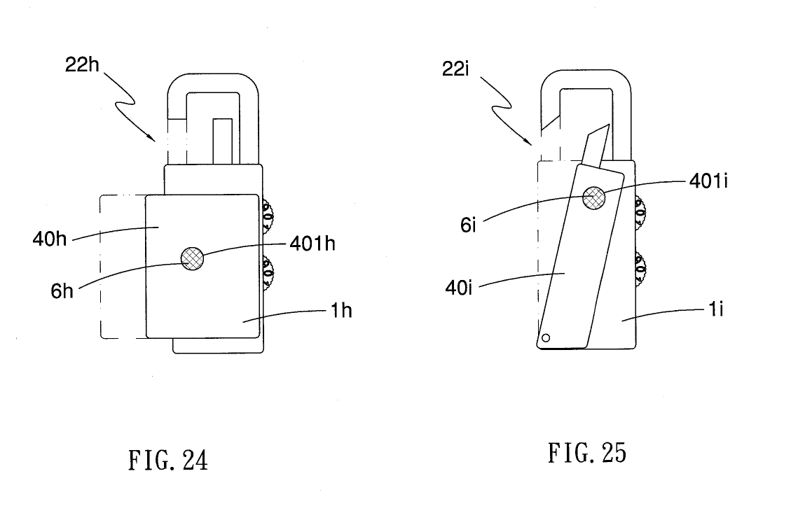

Referring to FIG. 24, a padlock in accordance with a tenth embodiment of the present invention includes a structure like that of the above embodiments. A limit knob 40h is transversely movable on a housing 1h to open a gap 22h so as to form an unlocked state so that an indication member 6h is moved with the limit knob 40h and exposed from a window 401h of the limit knob 40h.

Referring to FIG. 25, a padlock in accordance with an eleventh embodiment of the present invention includes a structure like that of the above embodiments. A limit knob 40i includes an end pivotally mounted on a bottom of a housing 1i. Thus, the limit knob 40i is pivoted on the housing 1i to open a gap 22i so as to form an unlocked state so that an indication member 6i is moved with the limit knob 40i and exposed from a window 401i of the limit knob 40i.

After a customs inspector has unlocked the padlock for checking the luggage, case or bag, the indication member is exposed and visible from the window of the limit knob for reminding a padlock owner whose padlock has been operated or used and luggage may have been inspected by the customs inspector. In addition, the padlock owner can directly and easily judge if the customs inspector has operated or used the padlock for checking the luggage. Furthermore, in the present invention, the movable block can be moved to the indication position not only by using the matching key to operate the lock core of the lock mechanism as above described, but also by any object which can reach or access to the lock core of the lock mechanism, especially the object which can reach or access to the movable block via the lock core, so as to further remind the padlock owner that the lock mechanism of the padlock has been used or touched.

In the foregoing embodiments, the movable block is mounted in the limit knob. However, in another embodiment or application, the movable block can be mounted outside the limit knob entirely or partially, and the window of the limit knob can be omitted. In the foregoing embodiments, the movable block can be moved in a rectilinear manner, i.e., lifted and lowered. In another embodiment or application, the movable block can however be moved in an angular manner, i.e., pivoted. In the foregoing embodiments, the lock core of the lock mechanism can include a first member non-movably mounted in the housing of the padlock, and a second member movably mounted in the first member and can be rotated by the matching key. However, in another embodiment, the lock core of the lock mechanism can be a one-piece element movably mounted in the housing of the padlock and can be rotated by the matching key.

Although the invention has been explained in relation to the foregoing embodiments, it is to be understood that many modifications and variations can be made without departing from the scope of the present invention. It is contemplated that the appended claim or claims will cover such modifications and variations that fall within the true scope of the invention.

1. A padlock comprising:
a housing defining an opening in a wall thereof to communicate an interior space of the housing and the outside of the housing;
a shackle having a shaft portion movably mounted in the housing, and a locking portion extended from the shaft portion and located outside of the housing;
a limit knob partly received in the housing via the opening and having a button located outside of the housing;
a movable block disposed on the limit knob and being capable of moving to a predetermined position which is outside of the housing;
a lock core having a rotor configured to be driven by a key;
wherein rotation of the rotor by the key drives the limit knob to move to a first position where the button of the limit knob keeps the shackle from rotating, and a second position where the button of the limit knob allows the shackle to rotate.

2. The padlock of claim 1, wherein the button of the limit knob defines a window and a chamber, and the movable block is received in the chamber and defines an identification area thereon which is visible from the window when the movable block is located in the predetermined position.

3. The padlock of claim 1, further comprising a number lock core positioned in the housing to control axial movement of the shaft portion of the shackle.

4. The padlock of claim 1, wherein the button of the limit knob defines a recess therein to receive the locking portion of the shackle in order to control rotation of the locking portion about the shaft portion of the shackle.

5. The padlock of claim 4, wherein the recess includes an open end at a periphery of the button.

6. The padlock of claim 2, wherein the button of the limit knob defines an aperture communicated with the chamber such that the movable block is able to be pushed back to an original position by an insert via the aperture; and the aperture is covered by the locking portion of the shackle when the button and the locking portion are coupled.
